(19) United States
(12) Patent Application Publication
(10) Pub. No.: US 2015/0186872 A1
(43) Pub. Date: Jul. 2, 2015

(54) TEMPORARY VIRTUAL CARD

(71) Applicant: BANK OF AMERICA CORPORATION, Charlotte, NC (US)

(72) Inventors: Craig Sobol, Waxhaw, NC (US); Julie Mann, Charlotte, NC (US)

(73) Assignee: BANK OF AMERICA CORPORATION, Charlotte, NC (US)

(21) Appl. No.: 14/145,978

(22) Filed: Jan. 1, 2014

(51) Int. Cl. G06Q 20/34; G06Q 20/32

(52) U.S. Cl. CPC G06Q 20/351; G06Q 20/322

(57) ABSTRACT

Embodiments of the invention relate to systems, methods, and computer program products for providing a temporary virtual transaction vehicle when a user misplaces a physical transaction card. The system, method, and computer program product are configured to: (a) receive a request, from a user, for a virtual transaction vehicle; (b) identify an existing account of the user to be linked with the virtual transaction vehicle; (c) generate the virtual transaction vehicle based at least partially on information associated with the request and identifying the account.

### BACKGROUND

Bank customers who lose their bank cards, such as a debit or credit card may sometimes have difficulty in obtaining a replacement bank card in a relatively short period of time. In many instances, once a customer misplaces and/or loses a bank card, that customer must go through a series of steps for obtaining a new bank card, which may often times includes waiting for several days to receive a new bank card. The process for obtaining a new bank card once a customer has misplaced an existing bank card is inconvenient and as such, there exists a need for an invention that overcomes the deficiencies of the current systems and methods for replacing a misplaced or lost bank card.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

An invention for providing a temporary virtual transaction vehicle for use with a mobile device is provided. In some embodiments, the invention includes a computer apparatus including a processor and a memory; and a software module stored in the memory, comprising executable instructions that when executed by the processor cause the processor to: (a) receive a request, from a user, for a virtual transaction vehicle; (b) identify an existing account of the user to be linked with the virtual transaction vehicle; (c) generate the virtual transaction vehicle based at least partially on information associated with the request and identifying the account.

In some embodiments, the request for the temporary virtual transaction vehicle is received via a mobile banking application executing on a mobile device of the user.

In some embodiments, the invention is configured to authenticate the user based on information associated with the request prior to generating the virtual transaction card.

In some embodiments, the invention is configured to authenticate the mobile device of the user prior to generating the virtual transaction card.

In some embodiments, generating the virtual transaction vehicle further comprises generating a new account number for the virtual transaction vehicle.

In some embodiments, the invention is configured to associate the new account number for the virtual transaction vehicle to the existing account of the user.

In some embodiments, the invention is configured to suspend or terminate an account number of a physical transaction vehicle that is associated with the existing account based at least partially on the generating the virtual transaction vehicle.

In some embodiments, the virtual transaction vehicle is useable only for shortened period of time, wherein the period of time is defined by an initial activation of the virtual transaction vehicle and an activating or a receiving of a permanent physical transaction vehicle that replaces the virtual transaction vehicle.

Other aspects and features, as recited by the claims, will become apparent to those skilled in the art upon review of the following non-limited detailed description of the invention in conjunction with the accompanying figures.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 is a flowchart illustrating a system and method for providing a temporary virtual transaction card, in accordance with various embodiments;

FIG. 2 provides a block diagram illustrating a system and environment for providing a temporary virtual transaction card, in accordance with various embodiments;

FIG. 2A is a block diagram illustrating technical components of a mobile device configured to initiate a request for a temporary virtual transaction vehicle, as well as receive for use the temporary virtual transaction vehicle, in accordance with various embodiments of the present invention.

### DETAILED DESCRIPTION

The embodiments presented herein are directed to systems, methods, and computer program products for providing a temporary virtual transaction vehicle to a customer. As presented herein, a user may request a temporary virtual transaction vehicle when the customer has misplaced or does not have available a physical transaction vehicle. In some embodiments, a system of a financial institution of the customer receives the request for the temporary virtual transaction vehicle and subsequently generates a new temporary transaction vehicle for the customer. In particular, system-generated temporary virtual transaction vehicle may include a new account number that is operatively connected to an existing account of the user or a completely new account created for the temporary transaction vehicle. Once generated, the system may transmit the temporary virtual transaction card to the customer for use on a mobile device of the customer until a new physical transaction card is provided to the user or the physical transaction card is once, again, available for use by the customer.

The embodiments of the disclosure may be embodied as a system, method, or computer program product. Accordingly, aspects of the present disclosure may take the form of an entirely hardware embodiment, an entirely software embodiment (including firmware, resident software, micro-code, and the like) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and the like, or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As presented herein, embodiments of the present invention relate to, at least, systems and methods directed to providing a user a temporary virtual transaction card, such as a virtual bank card. As referred to herein, the term “temporary virtual transaction card” refers to, but is not limited to, an electronic or digital transaction vehicle that can be used to transfer money, make a payment (for a service or a good), withdraw money, and similar or related transactions. Using an approved/authorized banking channel of communication, which may include making a phone call, accessing online banking, walking into a branch banking center, using an automatic teller machine, or the like, a user may indicate that an existing physical transaction card associated with one or more financial accounts of the user is misplaced, lost, or has been misappropriated. Once the user is authenticated via the authorized banking channel, a request may be submitted for the instance issuance of a temporary virtual transaction card in order to temporarily replace the misplaced or misappropriated physical transaction card. In response to the request the system may issue the temporary virtual transaction card directly to a mobile device of the user. In that way, the user may easily display the temporary virtual transaction card or generate indicia representing the temporary virtual transaction card for conducting a transaction.

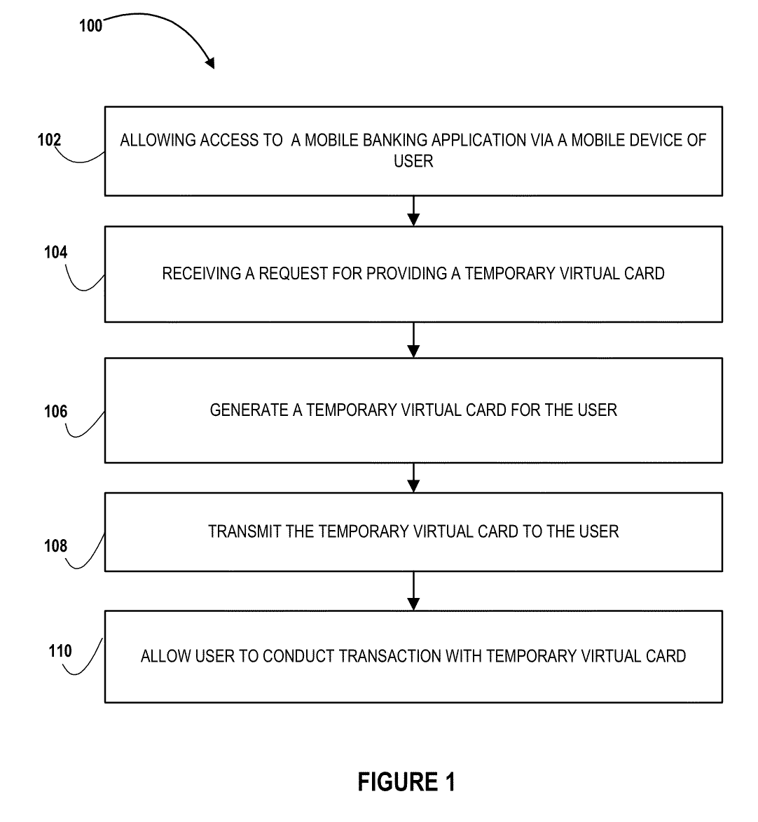

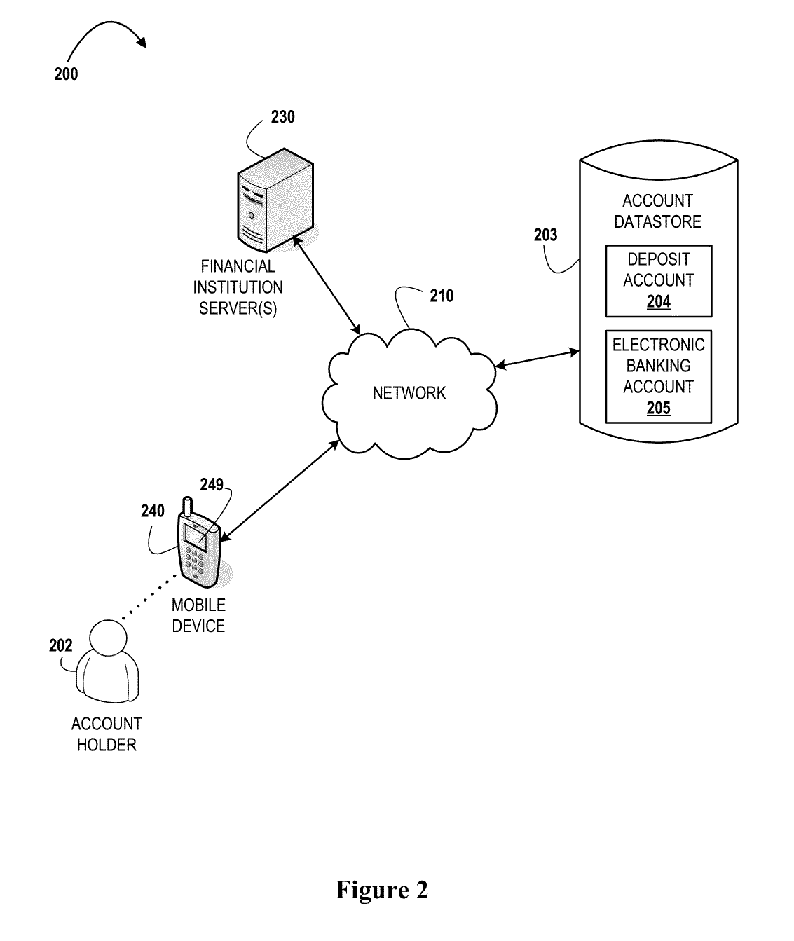

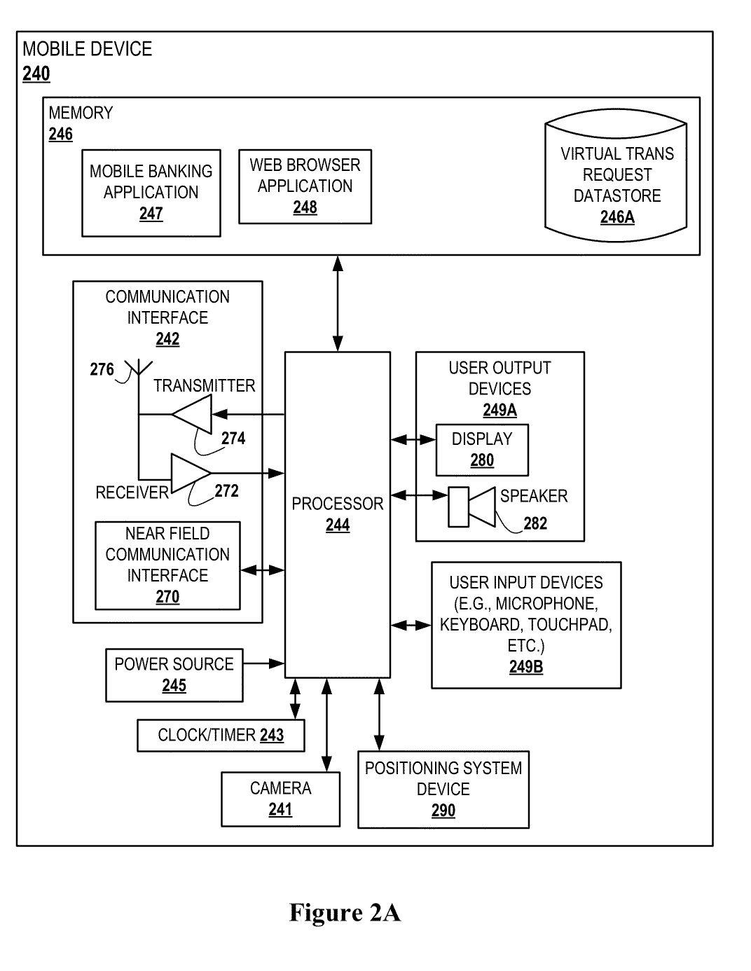

Referring now to the figures, FIG. 1 provides a flowchart illustrating a general process flow 100 for providing a temporary virtual transaction card, according to embodiments of the present invention. As described, the method may comprise one or more steps, as described herein below. One or more devices, such as the one or more systems and/or one or more computing devices and/or servers of FIG. 2, can be configured to perform one or more steps of the process 100 or other processes described below. In some embodiments, the one or more devices performing the steps are associated with a financial institution. In other embodiments, the one or more devices performing the steps are associated with a merchant, business, partner, third party, credit agency, account holder, and/or user.

At a time prior to making a request for issuance of the temporary virtual transaction card, a user may, in some instances of the invention, authenticate or register one or more mobile devices with an issuer of the physical transaction card that is temporarily replaced with the temporary virtual transaction card. As such, in some embodiments, the mobile device of the user is authenticated prior to receiving the request for the temporary virtual transaction card and/or attempting a transaction using, via the mobile device, the transaction card.

In some embodiments, authenticating a mobile device of the user that receives the temporary virtual transaction card involves sending an authentication request to a financial institution associated with the misplaced, lost, or otherwise unavailable physical transaction card in order to associate (e.g., enroll) the mobile device (e.g., a laptop, personal digital assistant (PDA), cell phone, smart phone, tablet, mp3 player, or any other suitable electronic device) with the user's online banking account and/or an account associated with the physical transaction card. The association request may be submitted by the mobile device via a mobile application (e.g., a mobile banking application) or via a mobile banking website and received by a system associated with the financial institution. For example, a mobile banking application downloaded onto the mobile device may prompt the customer to enroll the mobile device as a device for conducting transactions with a temporary virtual transaction card. In some embodiments, the mobile banking application is a mobile banking website accessed via the mobile device.

The association request typically includes device identification information associated with the mobile device and account identification information associated with the customer's transaction card account and/or an online banking account of the customer.

The device identification information associated with the mobile device may be any information sufficient to generate a device “fingerprint,” or unique signature of the customer's mobile device. Device identification information may be collected from a variety of sources. In some embodiments, the device identification information includes an identification code. The identification code may be but is not limited to a serial number or an item number of the device. In some embodiments, the device identification information may be associated with a chip associated with the mobile device. The chip may be but is not limited to a subscriber identification module (SIM) card, removable hard drive, processor, microprocessor, or the like. In other embodiments, the device identification information may be associated with a removable part of the mobile device. Removable parts include but are not limited to detachable keyboards, battery covers, cases, hardware accessories, or the like. Removable parts may contain serial numbers or part numbers. In some embodiments, device identification information may need to be entered manually at the mobile device. For example, the mobile banking system may prompt the customer for manual entry of the device identification information (e.g., a serial number, an identification code, an International Mobile Station Equipment Identity (IMEI), a phone number, a chip, a removable part, or similar pieces of device identification information). In other embodiments, device identification information may not be based on user input received at the mobile device. Instead, the device identification information may be automatically provided by the mobile device. In yet another embodiment, the mobile device may provide the information without requiring user input after receiving a request from the online banking system for the identification information.

The account identification information may be any information sufficient to identify the account associated with the physical transaction card, an online banking account, and/or other relevant financial accounts of the customer. In some embodiments, the account identification information may include, but is not limited to, at least one of a customer name, contact information, a username, a password, a PIN number, a unique identification number associated with the customer, social network information, an account number, or a card number. In some embodiments, the account identification information may be proprietary to the financial institution, such as an account number, a reference number to an account, a client number, or the like. In other embodiments, the account identification information may be public information, such as a phone number, mailing address, email address, or the like. The account identification information may be automatically provided by the mobile device. Alternatively, the customer may manually provide this information. For example, the customer may enter a username and a password associated with the customer's online banking account. The username and password may be provided in conjunction with the association request or may have been previously provided at the beginning of an online banking session, such as a mobile banking session (e.g., in order to log into a mobile banking application or mobile banking website). Accordingly, the account identification information may include information related to an mobile banking session

The method may additionally include authenticating the identity of the customer. For example, the mobile banking system may prompt the customer to enter authentication information (e.g., customer identification information) such as a username, a password, a personal identification number (PIN), a passcode, biometric information (e.g., voice authentication, a fingerprint, and/or a retina scan), or an answer to a security question. This authentication information may be used to authenticate the identity of the customer (e.g., determine that the authentication information is associated with the account) and determine that the customer has authority to access the online banking account. In some embodiments, this step of authenticating the identity of the customer may be part of a strong authentication process. A strong authentication process is a security measure that requires two or more authentication steps. In this regard, the customer may have previously provided a username and password when initiating a mobile banking session (e.g., when submitting an online banking session initiation request) or when submitting the association request. Accordingly, the customer may be prompted to enter additional authentication information (e.g., additional identification information), such as a PIN, biometric information, and/or an answer to a security question in order to further verify the identity of the customer (e.g., determine that the additional authentication information is associated with the online banking account).

After completing an initial authentication, the mobile device is associated (e.g., enrolled) with the customer's account associated with the physical transaction card and/or online banking account. In this regard, the account identification information and customer identification information provided by the customer is typically used to locate records (e.g., customer account information) in the online banking system associated with the customer's online banking account or transaction card account. Once the records associated with the customer's online banking account or transaction card account are located, an association is made between the identity of the mobile device and the customer's online banking account or transaction card account. Once the association is made, the online banking system or transaction card system typically creates an association record in memory of the association between the identity of the mobile device and the customer's online banking account or transaction card account.

In one embodiment, this association between the identity of the mobile device and the customer's online banking account or transaction card account indicates that the mobile device has permission to define access restrictions to the customer's online banking account or transaction card account. Furthermore, this association between the mobile device and the customer's online banking account or transaction card account may be used to associate the mobile device with the customer's identity. Accordingly, the identity of the mobile device may be used to identify the customer and to identify the customer's online banking account or transaction card account.

As illustrated at block 102, a user accesses a mobile banking application located on their mobile device. The mobile banking application may be presented on a graphical user interface (GUI) associated with the mobile device. Accessing the mobile banking application may comprise the user providing one or more login credentials prior to being granted access to the application. For example, a customer may be required to provide a user login and password associated with their online banking account prior to accessing the mobile banking application. In some embodiments, the login credentials are stored in the mobile device such that a user is only required to provide the login credentials when initially accessing the mobile banking application. In other embodiments, for added security, the user may be required to provide login credentials each time they access the mobile banking application.

The mobile banking application may be an application provided by the financial institution to allow customers to manage a number of financial accounts and conduct a number of financial transactions through a mobile device. The mobile banking application may be configured to connect with the financial institution via short message service (SMS) or mobile web associated with a respective mobile device. The mobile banking application may be associated with the customer's online banking account and account associated with a transaction card, such that transactions initiated and/or completed within the mobile banking application are processed by the financial institution and reflected in both the mobile banking application and the online banking account.

In some embodiments, the mobile banking application may monitor and/or track the location of the user, such that when the user utilizes the mobile banking application for requesting a temporary VTC, the mobile banking application may provide recommendations on how to proceed. Specifically, by geo-tracking or geo-locating the user, the mobile banking application is able to present to the user a list of locations at which the user can make a request for a temporary virtual transaction card or a temporary physical transaction card. The mobile banking application may populate a list of bank branches or ATMs with capabilities sufficient to help the user with his request.

At block 104, the user may provide information related to a request for receiving or activating a temporary virtual transaction card (“VTC”). The request for receiving the VTC may be completed by the user using an input device, such as a touch screen interface, associated with the mobile device. In some embodiments, a request for receiving a VTC comprises information that is provided by the mobile banking application and not expressly provided by or received from the user. For example, the request for a temporary VTC may include “standard” information such as customer name, customer address, account number, and/or authentication pin for the account, and the like. To this extent, the customer may only be responsible for inputting information specifically related to authenticating the user and identifying the account for which a temporary VTC is required. However, the mobile banking application contemporaneously with or during the time period that the user is providing input associated with the request for the VTC may access authentication information associated with the mobile device and subsequently append the authentication information associated with the mobile device together with the input provided by the user. In this way, the user authenticates him and identifies the relevant account for a VTC and the mobile banking application authenticates the mobile device. In many embodiments, it is necessary to additionally authenticate the mobile device in order to receive the temporary VTC. From the perspective of the financial institution providing the temporary VTC, the financial institution may require that temporary VTCs are provided only to registered mobile or computing devices that are properly authenticated. It will be understood that the authentication information associated with the mobile device may be communicated to the system or servers of the financial institution in any manner including, but not limited to, by appending the information to the user input, transmitting the mobile device authentication information separately (e.g., prior to user input or subsequent to user input), and the like. The authentication information associated with the mobile device may include any unique identifier associated with the mobile device and/or stored associated PIN code(s). For example, the mobile device may have previously registered with the financial institution of the user using a unique eight (8) digit identifier, such as ########. And during the user authentication process, the mobile device may retrieve the unique eight digit identifier from a secure storage associated with the mobile device for providing the eight digit code to the financial institution for authenticating the mobile device prior to providing a VTC to the mobile device. As such, in some embodiments, there may be a two-tiered authentication process for receiving a VTC that involves 1) authenticating the user and identifying an account and 2) authenticating, using the mobile banking application, the mobile of the user that is receiving the VTC.

At block 106, the system executing process flow 100 receives the request from the user and/or authentication information from the mobile banking application and in response to a successful authentication of the user and/or the mobile device of the user, the system automatically generates a temporary virtual transaction card for the user. In generating the VTC, the system generates a new card number that is different from the card number of the lost or misplaced physical transaction of the user. The system may also generate a new security code, such as a card verification value (CVV), and expiration date. In some embodiments, the CVV may be dynamic and may automatically change for different transaction. And again, in other embodiments, the user may be able to generate a one-time passcode/security code for the VTC, such as a new CVV number.

Still regarding block 106, the system may also associated the newly generated card number for the VTC to the account or account number of the misplaced or lost physical transaction card, so that the user may use the funds and/or the available credit associated with account associated with the physical transaction card. In other embodiments, the system creates a new account for the VTC that is distinct from the account of the misplaced or lost physical transaction card. And so, it will be understood that a card number or new number assigned to a VTC may be different and distinct from a number of the associated account maintained at the financial institution. So that, when a user loses or misplaces a debit card associated with a checking account with a financial institution, in some embodiments, only the number associated with the debit card is canceled and the account number of the checking remains the same because it may unaffected by the loss or misplacing of the debit card. In such an instance, the system may simply generate a card number for the VTC and operatively link the card number to the existing bank/credit account number of the user. In such an embodiment, the system may assign a new credit limit or available funds to the VTC that is less than the credit limit or available fund of the misplaced or lost physical transaction card. The new credit limit or available funds amount that is assigned to the VTC may be set by either the financial institution that maintains the account associated with the VTC or by the user who is the holder of the accounts associated with the VTC. In some embodiments, the new credit limit or funds available for the VTC is flexible and may fluctuate based on a transaction type or merchant codes involved in a transaction involving the VTC. For example, if the VTC is used in a transaction involving a grocer, the system may increase the new credit limit or funds available for these types of transactions involving a grocer. As such, the system may use a merchant codes to determine credit available or funds available for the VTC for conducting a transaction with a merchant associated certain merchant codes. Additionally, in some embodiments, when the system determines that the physical transaction card of the user is lost and not misplaced or in a location accessible by the user, the system automatically suspends or cancels the account associated with the lost physical transaction card prior to or contemporaneously with automatically generating the VTC. The system may determine that the physical transaction card is lost based on user input indicating that the physical transaction card is lost or has been misappropriated.

Referring now to block 108, the system executing process flow provides the newly generated VTC to the user. In such an embodiment, the system communicates information associated with the VTC to the mobile device of the user so that the user can easily access the VTC for use. Additionally, the system may provide disclosure information and instructions for using the VTC.

Lastly at block 110, the system allows the user to access the VTC on the mobile device of the user for performing one or more transactions. In some embodiments, the user is allowed to access the VTC via the mobile banking application on the mobile device. In such an embodiment, the user must first be authenticated by the mobile banking application prior to accessing the VTC for use. Similarly, the system may allow the user to use the mobile banking application to generate one or more security codes, such as a CVV, for the VTC in order to perform a transaction. Once the user accesses or activates the VTC, the mobile device is configured to (sometimes using the mobile banking application) generate indicia representing the VTC that may be used for performing the transaction. In some embodiments, the indicia a display of an electronic version of the physical transaction card that was lost or misplaced. And so, the electronic version will have an appearance of a physical credit or debit card or other type of card, which may include having the dimensions of a physical card, the name of the customer appearing on a front side of the card together with the card number, expiration date, card branding, and the like. In some embodiments, the indicia is a barcode, a quick response (QR) code, some machine-readable indicia, and the like that can be scanned for performing a transaction using the account associated with the VTC. In the embodiments where the VTC is a display of the VTC having an appearance of a physical transaction card, a portion of the display of the VTC may have a selectable portion that, when selected by the user, generates a CVV that is displayable thereon. For example, when a user is ready to perform a transaction, the user may access the VTC so that it displays onto the screen of the user's mobile device and then select a portion of the displayed VTC for generating a CVV that is provided together with the VTC number and/or expiration date that is required for processing a transaction. It will be understood that the VTC may be used in online and/or non-online transactions or in transactions. It will also be understood that, in some embodiments, the temporary VTC may cease to be accessible or used for transactions when a replacement physical transaction card is issued and/or activated by the user.

Referring now to FIG. 2, a system 200 for providing a temporary virtual transaction card is provided, in accordance with an embodiment of the present invention. As illustrated, the system 200 includes a network 210, financial institution servers 230, an account datastore 203, and a mobile device 240. As shown, the account datastore 203 includes a deposit account 204 and an electronic banking account 205. In this example embodiment, the deposit account 204 (e.g., checking account, savings account, investment account, etc.) is associated with the electronic banking account 205 (e.g., online banking account, mobile banking account, etc.). FIG. 2 also shows the account holder 202, who holds the deposit account 204 and has access to the mobile device 240. In accordance with some embodiments, a single bank maintains the account datastore 203 and the financial institution server 230. In some embodiments, the financial institution server 230 comprises multiple servers or is in communication with multiple servers. The financial institution server 230 may include one or more authorization servers and/or one or more servers for processing requests for virtual transaction cards and also for generating virtual transaction cards. In such embodiments, the holder 202 is a customer of the bank. Also, in accordance with some embodiments, the mobile device 240 is associated with the holder 202, and/or is carried, operated, controlled, possessed, and/or owned by the holder 202.

As shown in FIG. 2, the financial institution server 230 and the mobile device 240 are each operatively and selectively connected to the network 210, which may include one or more separate networks. The network 210 may include one or more interbank networks, telephone networks, telecommunication networks, cellular networks, NFC networks, local area networks (LANs), wide area networks (WANs), and/or global area networks (GANs) (e.g., the Internet, etc.). It will also be understood that the network 210 may be secure and/or unsecure and may also include wireless and/or wireline technology. Also, as shown in FIG. 2, the mobile device 240 is directly, selectively, and/or operatively connected to the financial institution server 230 via one or more wireline and/or wireless connections.

Each communication interface described herein, including the communication interface 242, generally includes hardware, and, in some instances, software, that enables a portion of the system 200, such as the mobile device 240, to send, receive, and/or otherwise communicate information to and/or from the communication interface of one or more other portions of the system 200. Each communication interface described herein can include a modem, network interface controller (NIC), NFC interface, network adapter, network interface card, transceiver, antenna, transmitter, receiver, and/or some other electronic communication device that operatively connects one apparatus to another.

Each processor described herein, including the processor 244, generally includes circuitry for implementing the audio, visual, and/or logic functions of that portion of the system 200. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the mobile banking application 247 of the memory 246 of the mobile device 240.

Each memory device described herein, including the memory 246 for storing the mobile banking application 247 and other information, may include any computer-readable medium. For example, the memory may include temporary and/or volatile memory, such as volatile random access memory (RAM) having a cache area for the temporary storage of data. Memory may also include non-temporary, non-volatile, and/or long-term persistent memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

Each user interface described herein, including the user interface 249, generally includes one or more user output devices for presenting information and/or one or more items to a user (e.g., the holder 202, etc.), such as, for example, one or more displays, speakers, receipt printers, dispensers (e.g., cash dispensers, ticket dispensers, merchandise dispensers, etc.), and/or the like. In some embodiments, the user interface additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the user (e.g., the holder 202, etc.).

Each datastore described herein, including the memory 246, and the account datastore 203, can be configured to store any type and/or amount of information. For example, in some embodiments, the memory 246 is configured to store transaction information associated with a virtual transaction vehicle. In some embodiments, the memory 246 includes one or more queues, lists, tables, dashboards, ledgers, etc. for organizing, displaying, and/or storing one or more virtual transaction cards and/or transaction associated therewith. The memory 246 or datastore 203 may include any one or more storage devices, including, but not limited to, datastores, databases, and/or any of the other storage devices typically associated with a mobile device, server, and/or computer system. It will also be understood that the datastores may store information in any known way, such as, for example, by using one or more computer codes and/or languages, alphanumeric character strings, data sets, figures, tables, charts, links, documents, and/or the like. Further, in some embodiments, the datastores include information associated with one or more applications, such as, for example, the mobile banking application 247. In some embodiments, each datastore provides a real-time or near real-time representation of the information stored therein, so that, for example, when a processor accesses that datastore, the information stored therein is current or nearly current.

Referring now to FIG. 2A, a block diagram is provided that illustrates the mobile device 240 of FIG. 2 in more detail, in accordance with an embodiment of the present invention. In some embodiments, the mobile device 240 is a mobile phone, but in other embodiments, the mobile device 240 can include and/or be embodied as any other mobile device described and/or contemplated herein. The mobile device 240 can be configured to initiate, perform, transmit, complete, and/or facilitate any portion of any embodiment described and/or contemplated herein as being initiated, performed, completed, and/or facilitated by a mobile device. As shown in FIG. 2A, the mobile device 240 includes a processor 244 operatively connected to memory 246, user output devices 249A, user input devices 249B, a communication interface 242, a power source 245, a clock or other timer 243, a camera 241, and a positioning system device 290.

The processor 244 may include the functionality to encode and interleave messages and data prior to modulation and transmission. The processor 244 can additionally include an internal data modem. Further, the processor 244 may include functionality to operate one or more software programs, which may be stored in the memory 246. For example, the processor 244 may be capable of operating a connectivity program, such as a web browser application 248. The web browser application 248 may then allow the mobile device 240 to transmit and receive web content, such as, for example, location-based content and/or other web page content, according to a Wireless Application Protocol (WAP), Hypertext Transfer Protocol (HTTP), and/or the like.

The processor 244 is configured to use the communication interface 242 to communicate with one or more other devices on the network 310. In this regard, the communication interface 242 includes an antenna 276 operatively coupled to a transmitter 274 and a receiver 272 (together a “transceiver”). The processor 244 is configured to provide signals to and receive signals from the transmitter 274 and receiver 272, respectively. The signals may include signaling information in accordance with the air interface standard of the applicable cellular system of the wireless telephone network 210. In this regard, the mobile device 240 may be configured to operate with one or more air interface standards, communication protocols, modulation types, and access types. By way of illustration, the mobile device 240 may be configured to operate in accordance with any of a number of first, second, third, and/or fourth-generation communication protocols and/or the like. For example, the mobile device 240 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 240 may also be configured to operate in accordance with non-cellular communication mechanisms, such as via a wireless local area network (WLAN) or other communication/data networks.

The communication interface 242 of the mobile device 240 may also include an NFC interface 270. The NFC interface 270 is configured to contactlessly and/or wirelessly send and/or receive information over relatively short ranges (e.g., within four inches, within three feet, etc.). The NFC interface 270 may include a transmitter, receiver, smart card, key card, proximity card, radio frequency identification (RFID) tag and/or reader, and/or the like. In some embodiments, the NFC interface 270 communicates information via radio, IR, and/or optical transmissions. In some embodiments, the NFC interface 270 is configured to operate as an NFC transmitter and/or as an NFC receiver (e.g., an NFC reader, etc.). In some embodiments, the NFC interface 270 enables the mobile device 240 to operate as a mobile wallet. Also, it will be understood that the NFC interface 270 may be embedded, built, carried, and/or otherwise supported in and/or on the mobile device 240. In some embodiments, the NFC interface 270 is not supported in and/or on the mobile device 240, but the NFC interface 270 is otherwise operatively connected to the mobile device 240 (e.g., where the NFC interface 270 is a peripheral device plugged into the mobile device 240, etc.). Other apparatuses having NFC interfaces mentioned herein may be configured similarly.

In some embodiments, the NFC interface 270 of the mobile device 240 is configured to contactlessly and/or wirelessly communicate information to and/or from a corresponding NFC interface of another apparatus. For example, in some embodiments, the mobile device 240 is a mobile phone, the NFC interface 270 is a smart card having transaction information associated with proposed transaction requests stored therein. In such embodiments, when the mobile phone and/or smart card is brought within a relatively short range of the NFC reader, the smart card is configured to wirelessly and/or contactlessly send the transaction information to the NFC reader in order to complete the proposed transaction request(s).

In addition to the NFC interface 270, the mobile device 240 can have a user interface 249 that is, like other user interfaces described herein, made up of one or more user output devices 249A and/or user input devices 249B. The user output devices 249A include a display 280 (e.g., a liquid crystal display, a touchscreen display, and/or the like) and a speaker 282 and/or other audio device, which are operatively coupled to the processor 244. The user input devices 249B, which allow the mobile device 240 to receive data from a user such as the holder 302, may include any of a number of devices allowing the mobile device 240 to receive data from a user, such as a keypad, keyboard, touch-screen, touchpad, microphone, mouse, joystick, other pointer device, button, soft key, and/or other input device(s). The user interface 249 may also include a camera 241, such as a digital camera.

In some embodiments, the mobile device 240 also includes a positioning system device 290 that can be used to determine the location of the mobile device 240. For example, the positioning system device 290 may include a GPS transceiver. In some embodiments, the positioning system device 290 is at least partially made up of the antenna 276, transmitter 274, and receiver 272 described above. For example, in one embodiment, triangulation of cellular signals may be used to identify the approximate location of the mobile device 240. In other embodiments, the positioning system device 290 includes a proximity sensor and/or transmitter, such as an RFID tag, that can sense or be sensed by devices known to be located proximate an ATM and/or other locations to determine that the mobile device 240 is located proximate these known devices.

The mobile device 240 further includes a power source 245, such as a battery, for powering various circuits and other devices that are used to operate the mobile device 240. Embodiments of the mobile device 240 may also include a clock or other timer 243 configured to determine and, in some cases, communicate actual or relative time to the processor 244 or one or more other devices.

The mobile device 240 also includes a memory 246 operatively connected to the processor 244. The memory 246 can store any of a number of applications which may include computer-executable program code executed by the processor 244 to implement the functions of the mobile device 240 described herein. For example, the memory 246 may include such applications as a web browser application 248 and/or a mobile banking application 247. It will be understood that the web browser application 248 and/or the mobile banking application 247 can be, individually or collectively, operable to initiate, perform, complete, and/or facilitate one or more portions of any embodiment described and/or contemplated herein, such as, for example, any one or more portions of the process flows 100 and/or 300 described herein.

For example, in some embodiments, the mobile banking application 247 is executable to authenticate the holder 202. As another example, in some embodiments, the mobile banking application 247 is executable to prompt (e.g., via the user interface 249) the holder 202 to input, into the mobile device 240, information for initiating one or more virtual transaction card requests. As still another example, in some embodiments, the mobile banking application 247 is executable to initiate one or more virtual transaction card requests. As another example, in some embodiments, the mobile banking application 247 is executable to store transaction information associated with one or more virtual transaction card requests in the virtual transaction card request datastore 246A and/or elsewhere in the memory 246. As another example, in some embodiments, the mobile banking application 247 is executable to store authentication information associated with one or more virtual transaction card requests in the virtual transaction card requests datastore 246A. As still another example, in some embodiments, the mobile banking application 247 is executable to present information associated with one or more virtual transaction card requests to the holder 202 and/or to prompt the holder to select one or more accounts for generating a virtual transaction card (e.g., virtual card generation by the server 230). As another example, in some embodiments, the mobile banking application 247 is executable to transfer information associated with the one or more virtual transaction card requests directly and/or indirectly between the mobile device 240 and the financial institution server 230.

In some embodiments, the mobile banking application 247 and/or the web browser application 248 are executable to enable the holder 202 and/or mobile device 240 to communicate with one or more other portions of the system 200, and/or vice versa. In some embodiments, the mobile banking application 247 and/or the web browser application 248 is additionally or alternatively executable to initiate, perform, complete, and/or otherwise facilitate one or more financial and/or non-financial transactions. In some embodiments, the mobile banking application 247 and/or the web browser application 248 includes one or more computer-executable program code portions for causing and/or instructing the processor 244 to perform one or more of the functions of the mobile banking application 247, web browser application 248, and/or mobile device 240 described and/or contemplated herein. In some embodiments, the mobile banking application 247 and/or the web browser application 248 includes and/or uses one or more network and/or system communication protocols.

In some embodiments, the mobile banking application 247 and/or the web browser application 248 are executable to render and/or otherwise provide a graphical user interface on the display 280 that allows the holder 202 to communicate with the mobile device 240, the financial institution server 230, and/or one or more other portions of the system 200. In some embodiments, the holder 202 can use the mobile banking application 247 and/or the web browser application 248 to access the electronic banking account 209 (e.g., mobile banking account, etc.) that is associated with the deposit account 204. The memory 246 can also store any type and/or amount information used by the mobile device 240, and/or used by the applications and/or the devices that make up the mobile device 240 and/or that are in communication with the mobile device 240, to implement the functions of the mobile device 240 and/or the other systems described and/or contemplated herein. For example, in some embodiments, the memory 246 stores account information (e.g., routing and/or account numbers, account names, etc.), authentication information (e.g., username/passwords, PINs, tokens, biometric information, etc.) associated with one or more virtual transaction card requests, and/or transaction information associated with one or more virtual transaction cards in the memory 246.

FIG. 2 also illustrates financial institution server(s) 230, in accordance with some embodiments of the present invention. The financial institution server 230 can include any server and/or apparatus described and/or contemplated herein. Additionally or alternatively, the server 230 can be configured to initiate, perform, complete, and/or facilitate any portion of any embodiment described and/or contemplated herein as being initiated, performed, completed, and/or facilitated by a server and/or apparatus. In some embodiments, the server 230 includes one or more servers, engines, mainframes, personal computers, ATMs, network devices, front end systems, back end systems, and/or the like. It will be understood that the server 230 may include a communication interface, a processor, and a memory, which may include one or more applications and/or datastores.

In some embodiments, the server 230 is configured (and/or an application thereof is executable) to receive a request for a temporary virtual transaction card. In some embodiments, the server 230 is configured (and/or an application thereof is executable) to receive, either individually or together, authentication information associated with the user submitting the request and/or authentication information associated with a mobile device from which the request is received. In some embodiments, the server 230 is configured to authenticate, either individually or together, the user and/or the mobile device prior to generating a temporary virtual transaction. Once server 230 determines that either or both the user and/or the mobile device are authorized for a temporary virtual transaction card, the server 230 is configured to: 1) generate a new account number for the virtual transaction card, 2) link the new account number to an existing account number of the user, 3) render a virtual transaction card comprising the new account number, and 4) transmit the rendering of the virtual transaction card to the authenticated mobile device of the user. In an alternative embodiment, the server 230 may be configured to generate indicia representing the virtual transaction card, in lieu of the rendering.

In some embodiments, the server 230 is configured to: (a) receive a request, from the mobile device 240, for a virtual transaction vehicle, where the request is provided, using one or more inputs, into the mobile device 240 by the holder 202; (b) identify an existing account of the user to be linked with the virtual transaction vehicle based on the information associated with the request (e.g., identify the account associated with the misplaced physical transaction card); and (c) generate the virtual transaction vehicle based at least partially on information associated with the request and identifying the account; and (d) transmit the newly generated virtual transaction vehicle to the mobile device of the user so that the user can perform transactions using the virtual transaction card.

In some embodiments, the financial institution server 230 is configured to communicate with one or more other portions of the system 200, such as, for example, the datastore 203, the mobile device 240, and/or vice versa. Also, in some embodiments, the s financial institution server 230 includes one or more applications, where those one or more applications include one or more computer-executable program code portions for causing and/or instructing the processor of the financial institution server 230 to perform one or more of the functions of the financial institution server 230 described and/or contemplated herein. In some embodiments, the financial institution server 230 includes and/or uses one or more network and/or system communication protocols.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. Thus, although not expressly described, any or each of the features of the invention disclosed herein may be combined in any manner. The following claims are in no way intended to limit the scope of embodiments of the disclosure to the specific embodiments described herein.

1. A system for providing a virtual transaction vehicle to a user, the system comprising:
a computer apparatus including a processor and a memory; and
a software module stored in the memory, comprising executable instructions that when executed by the processor cause the processor to:
configure the memory to store transaction information associated with a virtual transaction vehicle for use with a mobile device of a user;
receive a request, from the mobile device of the user, for a transaction via the virtual transaction vehicle, wherein the virtual transaction vehicle is a mechanism to generate a virtual transaction card;
identify an existing account of the user to be linked with the virtual transaction vehicle;
generate the virtual transaction vehicle, in response to the request of the user, based at least partially on information associated with the request and identifying the account, wherein generating the virtual transaction vehicle comprises generating a new account number for the virtual transaction vehicle and associating the new account number with the existing account of the user; and
issue and store a virtual transaction card on the mobile device of the user, whereby allowing the mobile device to communicate and complete a transaction via the virtual transaction vehicle.

2. The system of claim 1, wherein the request for the virtual transaction vehicle is received via a mobile banking application executing on a mobile device of the user.

3. The system of claim 1, wherein the executable instructions further causes the processor to authenticate the user based on information associated with the request prior to generating the virtual transaction card.

4. The system of claim 2, wherein the executable instructions further causes the processor to authenticate the mobile device of the user prior to generating the virtual transaction card.

5. (canceled)

6. (canceled)

7. The system of claim 1, wherein the executable instructions further cause the processor to: suspend or terminate an account number of a physical transaction vehicle that is associated with the existing account based at least partially on the generating the virtual transaction vehicle.

8. The system of claim 1, wherein the virtual transaction vehicle is useable only for shortened period of time, wherein the period of time is defined by an initial activation of the virtual transaction vehicle and an activation or a receiving of a permanent physical transaction vehicle that replaces the virtual transaction vehicle.

9. A computer program product for providing a virtual transaction vehicle to a user, the computer program product comprising a non-transitory computer-readable medium, wherein the non-transitory computer-readable medium comprises one or more computer-executable program code portions that, when executed by a computer, cause the computer to:
configure the memory to store transaction information associated with a virtual transaction vehicle for use with a mobile device of a user;
receive a request, from the mobile device of the user, for a transaction via the virtual transaction vehicle, wherein the virtual transaction vehicle is a mechanism to generate a virtual transaction card;
identify an existing account of the user to be linked with the virtual transaction vehicle;
generate the virtual transaction vehicle, in response to the request of the user, based at least partially on information associated with the request and identifying the account, wherein generating the virtual transaction vehicle comprises generating a new account number for the virtual transaction vehicle and associating the new account number with the existing account of the user; and
issue and store a virtual transaction card on the mobile device of the user, whereby allowing the mobile device to communicate and complete a transaction via the virtual transaction vehicle.

10. The computer program product of claim 9, wherein the request for the virtual transaction vehicle is received via a mobile banking application executing on a mobile device of the user.

11. The computer program product of claim 9, wherein the computer program code further comprises one or more executable program portions that cause the computer to authenticate the user based on information associated with the request prior to generating the virtual transaction card.

12. The computer program product of claim 10, wherein the computer program code further comprises one or more executable program portions that cause the computer to authenticate the mobile device of the user prior to generating the virtual transaction card.

13. (canceled)

14. (canceled)

15. A computer-implemented method for providing a virtual transaction vehicle to a user, the method comprising:
configure the memory to store transaction information associated with a virtual transaction vehicle for use with a mobile device of a user;
receive a request, from the mobile device of the user, for a transaction via the virtual transaction vehicle, wherein the virtual transaction vehicle is a mechanism to generate a virtual transaction card;
identify an existing account of the user to be linked with the virtual transaction vehicle;
generate the virtual transaction vehicle, in response to the request of the user, based at least partially on information associated with the request and identifying the account, wherein generating the virtual transaction vehicle comprises generating a new account number for the virtual transaction vehicle and associating the new account number with the existing account of the user; and
issue and store a virtual transaction card on the mobile device of the user, whereby allowing the mobile device to communicate and complete a transaction via the virtual transaction vehicle.

16. The method of claim 15, wherein the request for the virtual transaction vehicle is received via a mobile banking application executing on a mobile device of the user.

17. The computer-implemented method of claim 15, further comprises authenticating the user based on information associated with the request prior to generating the virtual transaction card.

18. The computer-implemented method of claim 16, further comprises authenticating the mobile device of the user prior to generating the virtual transaction card.

19. (canceled)

20. (canceled)
